(19) United States
(12) Patent Application Publication
(10) Pub. No.: US 2007/0093135 A1
(43) Pub. Date: Apr. 26, 2007

(54) ENCLOSURE WITH EMI SHIELD

(75) Inventors: Qing-Bin Luo, Shenzhen (CN); Chin-Yu Huang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,413

(22) Filed: Aug. 4, 2006

(30) Foreign Application Priority Data
Oct. 26, 2005 (CN) 200520066466.8

(51) Int. Cl. H01R 9/03

(52) U.S. Cl. 439/610

(57) ABSTRACT

An exemplary enclosure includes a housing to enclose a motherboard therein. The motherboard has a USB connector mounted thereon. The housing includes a front panel and a bottom plate. The front panel has a USB plug mounted thereon. A cable shield is formed on the bottom plate. A cable passing through the cable shield connects the USB plug and the USB connector. The cable shield is provided between the cables and components on the motherboard, EMI caused by the cable won't negatively influence operation of the components on the motherboard.

### 1. FIELD OF THE INVENTION

The present invention relates to electromagnetic Interference (EMI) shields, and particularly to an EMI resistant enclosure.

### 2. DESCRIPTION OF RELATED ART

In the enclosure of a typical electronic device, electromagnetic interference (EMI) is a common problem faced during the operation of electronic equipment. EMI is unwanted electromagnetic energy entering or emitting from a specific piece of electronic equipment, thereby causing interference. EMI can cause that piece of electronic equipment or other electronic equipment nearby to malfunction.

Referring to FIG. 3, a conventional enclosure of a typical electronic device is shown. The enclosure 10 has a Universal Serial Bus (USB) plug 142 and an audio port 144 mounted on a front panel 14 of the enclosure 10. The enclosure 10 has a motherboard 16 housed therein. A USB connector 162 and an audio connector 164 are mounted on the motherboard 16 corresponding with the connectors on the front panel 14. A USB cable 17 and an audio cable 18 connect connectors 162, 164 on the motherboard 16 and connecters 142,144 on the front panel 14 respectively. The USB cable 17 and the audio cable 18 may emit electromagnetic radiation during operation and the EMI may negatively influence other components mounted on the motherboard 16.

What is needed is to provide shielding to reduce EMI caused by cables in the enclosure.

### SUMMARY OF THE INVENTION

An exemplary enclosure includes a housing to enclose a motherboard therein. The motherboard has a USB connector mounted thereon. The housing includes a front panel and a bottom plate. The front panel has a USB plug mounted thereon. A cable shield is formed on the bottom plate. A cable passing through the cable shield connects the USB plug and the USB connector.

Other advantages and novel features of the invention will become more apparent from the following detailed description when taken in conjunction with the accompanying drawings, in which:

### BRIEF DESCRIPTION OF THE DRAWINGS

FIG. 1 is an isometric view of an enclosure with a cable shield in accordance with a preferred embodiment of the present invention;

FIG. 2 is an enlarged cross-sectional view taken along line III-III of FIG. 1; and

FIG. 3 is an isometric view of a conventional enclosure.

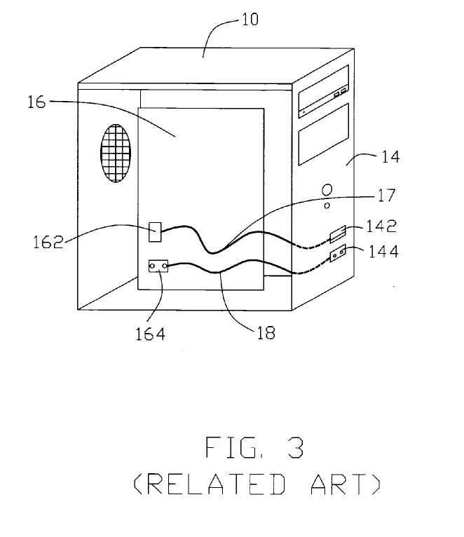

### DETAILED DESCRIPTION OF THE INVENTION

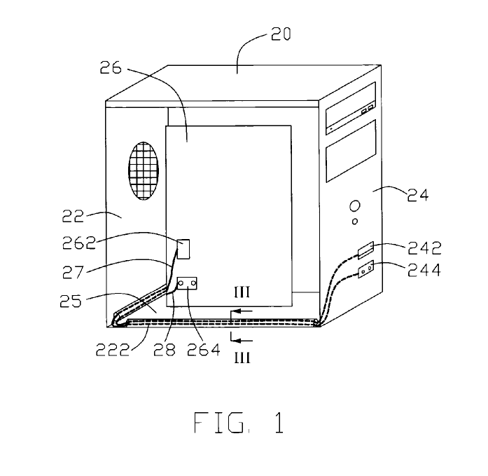

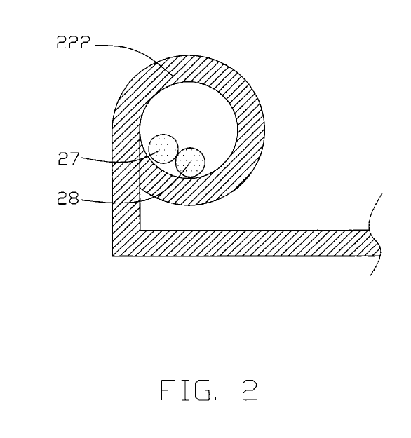

Referring to FIG. 1, an enclosure 20 in accordance with a preferred embodiment of the present invention includes a housing 22 formed of a plurality of walls made of an electrically conductive material, for example, sheet metal. The housing 22 includes a front panel 24 and a bottom plate 25. A USB plug 242 and an audio port 244 are mounted on the front panel 24. A cable shield 222 is folded from a flange of the bottom plate 25 to form a circular pipe as shown in FIG. 2. A motherboard 26 is mounted in the housing 22 with a USB connector 262 and an audio connector 264 mounted thereon. A USB cable 27 passes through the cable shield 222 to connect the USB plug 242 of the front panel 24 with the USB connector 262 of the motherboard 26. An audio cable 28 passes through the cable shield 222 to connect the audio port 244 of the front panel 24 with the audio connector 264 of the motherboard 26. In this configuration, the USB cable 27 and the audio cable 28 are shielded by the cable shield 222, providing mutual EMI protection between the cables and components on the motherboard 26.

Although FIG. 2 is illustrated with a circular cable shield 222, it should be appreciated that any shape of cable shield can be attached to the enclosure, such as triangular and rectangular. And it should be further appreciated by one skilled in the art that the cable shield can be attached to the enclosure using a variety of methods such as welding or screwing, and the like.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. An electronic enclosure for EMI shielding, comprising:
a housing enclosing a plurality of electronic devices and cables connecting the electronic devices; and
a cable shield formed on the housing for cables passing therethrough.

2. The electronic enclosure as claimed in claim 1, wherein the housing includes a bottom plate, the cable shield is folded or rolled from a flange of the bottom plate.

3. The electronic enclosure as claimed in claim 1, wherein a section of the cable shield is circular.

4. The electronic enclosure as claimed in claim 1, wherein a section of the cable shield is triangular.

5. The electronic enclosure as claimed in claim 1, wherein a section of the cable shield is rectangular.

6. An enclosure comprising:
a plurality of walls configured to enclose a motherboard therein, one of the walls having a port defined thereon;
a connector formed on the motherboard;
a cable connecting the port of the one of the walls and the connector of the mother board; and
a cable shield formed on one of the walls for the cable passing therethrough.

7. The enclosure as claimed in claim 6, wherein the connector is a USB connector, and the port is a USB plug.

8. The enclosure as claimed in claim 6, wherein the connector is an audio connector, and the port is an audio port.

9. The enclosure as claimed in claim 6, wherein the cable shield is folded or rolled from a flange of the one of the walls.
